(19) United States
(12) Patent Application Publication
(10) Pub. No.: US 2014/0157184 A1
(43) Pub. Date: Jun. 5, 2014

(54) CONTROL OF USER NOTIFICATION WINDOW DISPLAY

(71) Applicant: INTERNATIONAL BUSINESS MACHINES CORPORATION, Armonk, NY (US)

(72) Inventors: Sandro Piccinini, Rome (IT); Milko Vaccaro, Rome (IT)

(73) Assignee: INTERNATIONAL BUSINESS MACHINES CORPORATION, Armonk, NY (US)

(21) Appl. No.: 13/690,699

(22) Filed: Nov. 30, 2012

(51) Int. Cl. G06F 3/0481

(52) U.S. Cl. CPC G06F 3/0481
USPC 715/781

(57) ABSTRACT

A method for controlling a user notification window (UNW). Under this method: (i) an initial-form UNW is generated in response to detection of existence of a first precondition; (ii) the first initial-form UNW is displayed on a display device; and (iii) subsequent to the initial display of the initial-form UNW and in response to the detection of a second precondition, control is applied that overwrites the display of the first initial-form UNW on the display device. The second precondition is a precondition other than a response made by a user of the display.

### FIELD OF THE INVENTION

The present invention relates generally to the field of displaying user notification windows that pop up and relate to the user interface of an application (herein called simply “user notification windows, or, even more simply, “UNWs”), and more particularly to control of the manner in which UNWs are displayed to the user over the life of the UNW.

### BACKGROUND OF THE INVENTION

UNWs are known and used for many applications. For example, FIG. 1 shows screenshot 100 including: application window 102; UNW display 101; and close button 103. In this example, the application is a document editing program, and UNW 101 explains to the user one way that the document editing program may be closed. As is typical, there is a response mechanism (in this case, close button 103) for the user to indicate that he is finished reading the UNW. As a further example, FIG. 2 shows screenshot 190 including: UNW 191; first response mechanism 192; second response mechanism 193; third response mechanism 194; and operating system desktop display 195. In the example of screen shot 190, the UNW appears even though the application to which the UNW relates is not open.

Some applications which have UNWs are considered as “business applications” because the application has a substantial business purpose (even if it additionally has other purposes). Herein, UNWs that relate to business applications will sometimes be referred to herein as BUNWs (for “business user notification window”). A business application may have more than one user interface. For example, an enterprise product typically has a first user interface to configure the application, a second user interface to manage the application, a third interface to substantively utilize the application and so on. Generally, the users of such interfaces have different respective roles in the business organization (such as, administrator, configurator, security, operator and so on). Each role is often performed by multiple individual users acting co-operatively. For example, a business application may have multiple administrators, with each administrator-user typically using an administrator's user interface designed for performing administrative tasks with respect to the business application.

### SUMMARY

A method for controlling a user notification window (UNW) includes the following steps (not necessarily in the following order except to the extent explicitly indicated and possibly overlapping in time): (i) generating, by a UNW module, a first initial-form UNW in response to detection of existence of a first precondition; (ii) displaying, by the UNW module, the first initial-form UNW on a display device; and (iii) subsequent to the displaying step, applying, by the UNW module and in response to the detection of a second precondition, control that overwrites the display (see definition of “overwrites the display” herein) of the first initial-form UNW on the display device. The UNW module includes software running on processing hardware. The second precondition is a precondition other than a response made by a user of the display.

The following paragraphs provide definitions for certain term(s) used in this document:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: non-exclusive or; for example, A and/or B means that: (i) A is true and B is false; or (ii) A is false and B is true; or (iii) A and B are both true.

Overwrites the display: at least one of the following happens: (i) the UNW is removed from the user's display; and/or (ii) an initial-form UNW is replaced and superseded by a subsequent-form UNW.

### BRIEF DESCRIPTION OF THE SEVERAL VIEWS OF THE DRAWINGS

FIG. 1 is a screen shot view of a display including a first prior art UNW;

FIG. 2 is a screen shot view of a display including a second prior art UNW;

FIG. 3 is a schematic diagram of a first embodiment of a computer system according to the present invention;

FIG. 4 is a schematic diagram of a portion of the first embodiment system;

FIG. 5 is a schematic diagram of a portion of the first embodiment system;

FIG. 6A is a screen shot view of a display including a UNW generated by the first embodiment system;

FIG. 6B is a screen shot view of a display including a UNW generated by the first embodiment system;

FIG. 7A is a screen shot view of a display including a UNW generated by the first embodiment system;

FIG. 7B is a screen shot view of a display including a UNW generated by the first embodiment system;

FIG. 8 is a schematic diagram of a portion of the first embodiment system;

FIG. 9A is a flowchart of a first process according to the present invention; and

FIG. 9B is a flowchart of a first process according to the present invention.

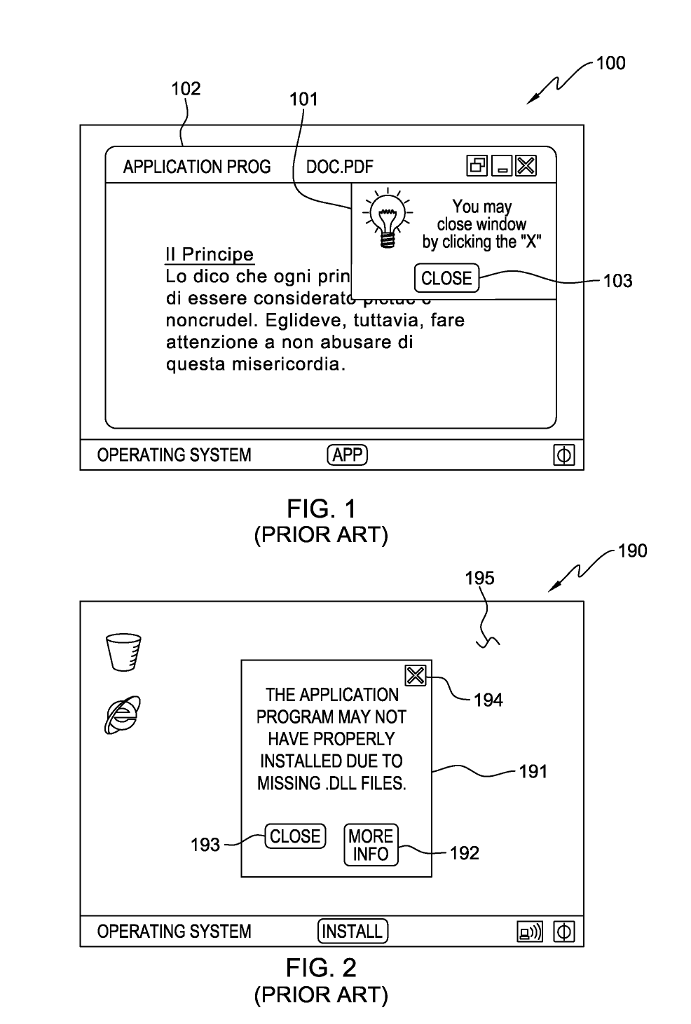

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

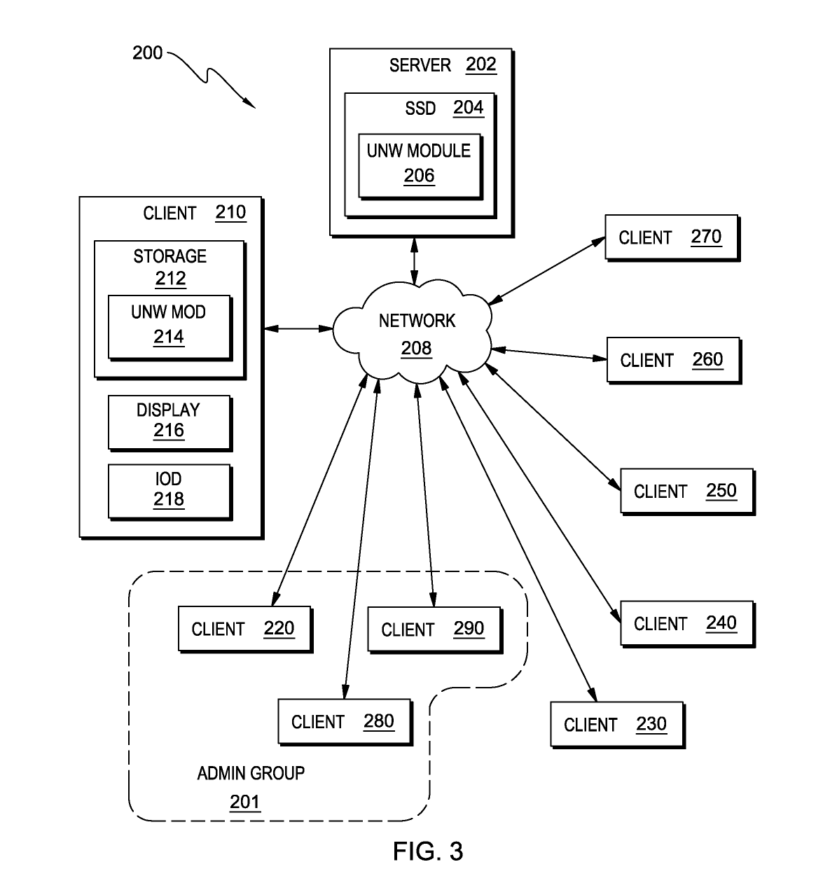

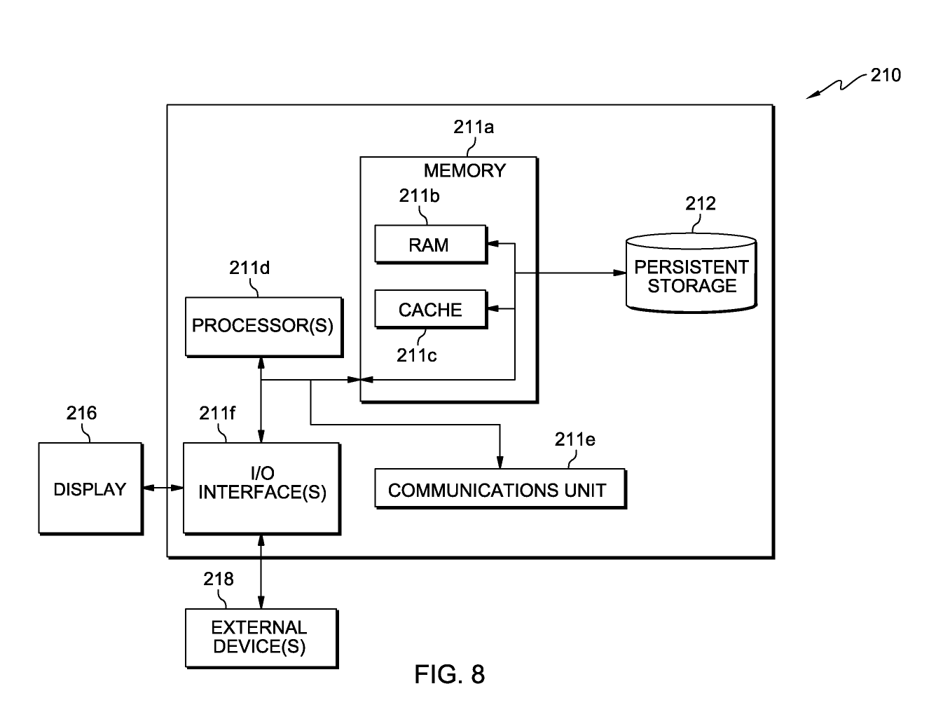

The present invention will now be described in detail with reference to FIGS. 3 to 9B. FIG. 3 is a functional block diagram illustrating a distributed data processing environment, generally designated 200, in accordance with one embodiment of the present invention. As shown in FIGS. 3 to 9B, system 200 includes: server computer sub-system 202; communication network 208; and client computer sub-systems 210, 220, 230, 240, 250, 260, 270, 280, 290. As shown in FIGS. 3 and 8, typical client computer sub-system 210 includes: memory 211a (including random access memory (RAM) 211b and cache 211c); processor set 211d; network communications unit 211e; input-output (I/O) interface(s) module 211f; persistent storage device (and/or medium) 212; display device 216; and input/output device set (also called external device(s) 218. As shown in FIG. 3, three of the client sub-systems are logically organized into admin group 201 because the users of these particular client sub-systems are have the role of system administrators with respect to the business application that is being run in this example. The client computer sub-system structure shown in FIG. 8 may also be used for server computer sub-system 202.

The client and/or server sub-systems may be distributed (locally or non-locally) or multiple machines, computers and/or devices. In some system embodiments, there may be only a standalone client system. In other system embodiments, the client sub-system may include little or no processing power, with substantially all logic functionality being provided by the (generally remote) server sub-system.

Server computer sub-system 202 may take the form of a laptop computer, tablet computer, netbook computer, personal computer (PC), a desktop computer, a personal digital assistant (PDA), a smart phone, or any programmable electronic device capable of communicating with the client sub-systems via network 208. In various embodiments of the present invention, the client sub-systems can each respectively take the form of a laptop computer, tablet computer, netbook computer, personal computer (PC), a desktop computer, a personal digital assistant (PDA), a smart phone, or any programmable electronic device capable of communicating with server computer 202 via network 208.

Network 208 can be, for example, a local area network (LAN), a wide area network (WAN) such as the Internet, or a combination of the two, and can include wired, wireless, or fiber optic connections. In general, network 208 can be any combination of connections and protocols that will support communications between server computer 202 and the various client sub-systems.

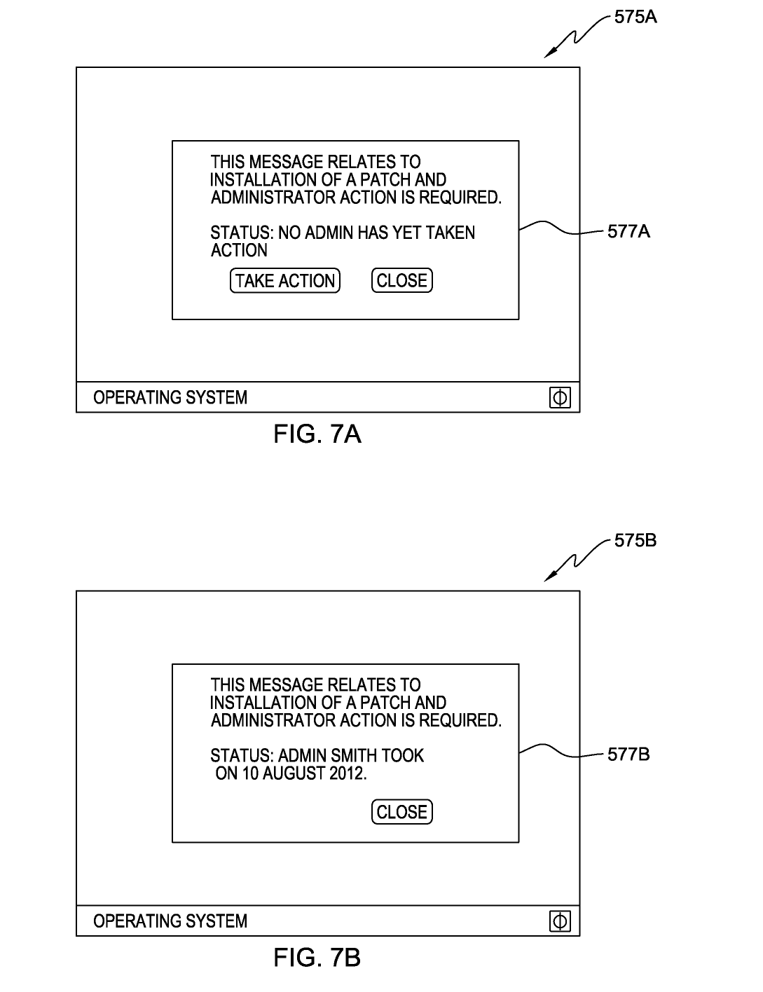

As shown in FIG. 3, server 202 includes software storage device 204. Software storage device 204 has stored thereon UNW module 206. As shown in FIG. 7, UNW module 206 includes: UNW generation sub-module 302; UNW distribution sub-module 304; and external rule repository 314. UNW distribution sub-module 304 includes push sub-sub module 306; dynamic control data collection sub-sub-module 310; and dynamic control rules sub-sub-module 312 (including rules database 313).

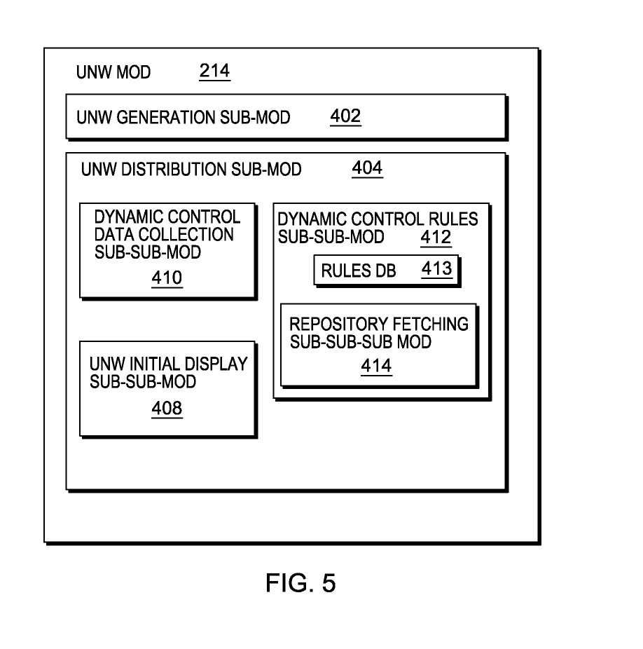

As shown in FIG. 3, persistent storage device 212 of client computer sub-system 210 has stored thereon UNW module 214. As shown in FIG. 5, UNW module 214 includes: UNW generation sub-module 402; and UNW distribution sub-module 404. UNW distribution module 404 includes: dynamic control data collection sub-sub-module 410; dynamic control rules sub-sub-module 412; and UNW initial-display sub-sub-module 408. Dynamic control rules sub-sub-module 412 includes rules database 413 and repository fetching sub-sub-sub-module 414.

In embodiment 200, the control of UNWs on display 216 of client sub-system 210 is shared by: (i) UNW module 206 of server 202; and (ii) UNW module 214 of client 210. In other words, in this example, control of the way UNWs are displayed and/or otherwise handled is partially central control and partially local control. As a related note on terminology used herein, modules 206 and 214 may be considered as a single “module” in this example. This can be implemented by ensuring that modules 206 and 214 co-operate so that there are not error-causing conflicts in the way UNWs are generated, displayed, disposed of and/or overwritten. Alternatively, modules 206 and 214 may control different UNWs, with each UNW being handled by module 206 or module 214 depending upon the relevant characteristics of the UNW itself. As a further alternative, and as mentioned above, either the client (that is module 214) or the server (that is, module 206) could perform all control of all UNWs displayed at display 216 of client sub-system 210.

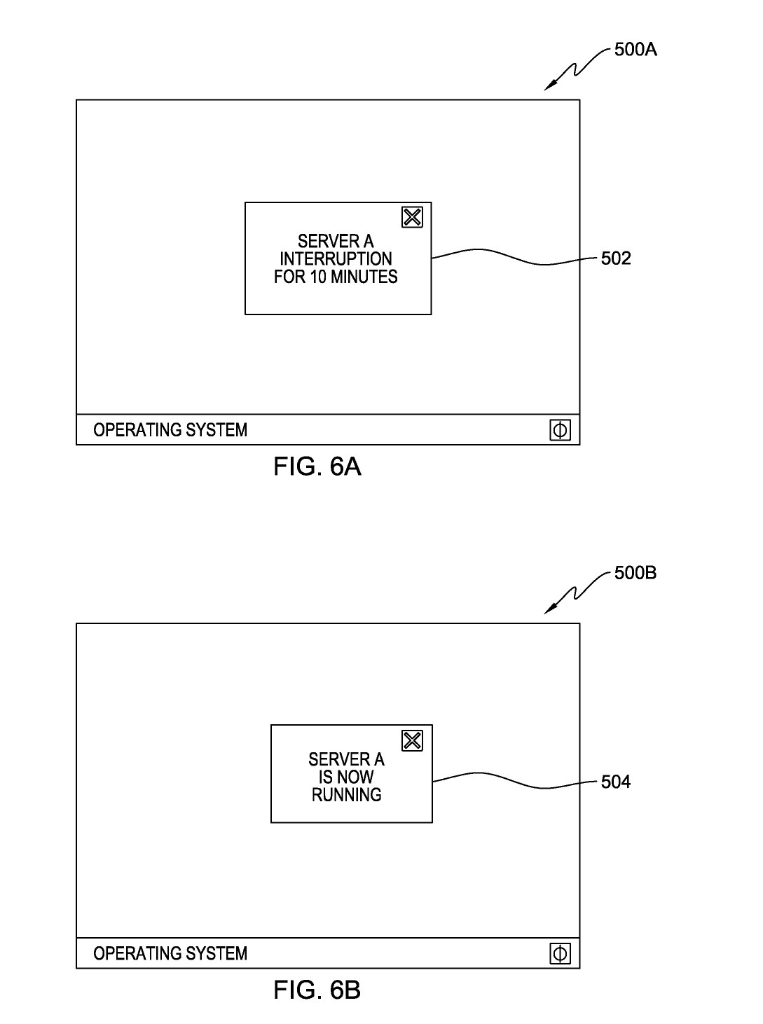

Two specific examples of the improved dynamic UNW control of the present invention will now be discussed in connection with FIGS. 6A to 6B, and 7A to 7B.

FIG. 6A shows screen shot 500A including UNW 502. UNW 502 relates to an unexpected server interruption with respect to a server that serves some of the data related to the business application. This UNW 502 may be generated, sent and displayed by push sub-sub-module 306 and/or UNW initial-form display sub-sub-module 408 using conventional techniques for displaying UNWs in the first instance. However, as this UNW 502 is displayed over time to a given user, and is not closed by the user at his client sub-system, the server interruption ceases of its own accord and is there is no longer any interruption. According to the dynamic control of the present invention, when the server interruption has been determined to be ended, then UNW is overwritten. In this example, UNW 502 is overwritten because it is replaced by UNW 504 as shown in display 500B in FIG. 6B. While a conventional system might well put up UNW similar to UNW 504 upon resumption of service of the server, under the dynamic control of the present invention, UNW 502 is actually removed based on events occurring in the system after UNW 502 has already been pushed and displayed. In a conventional system, the user at the client sub-system would need to actively close UNW 502, even if UNW 504 were displayed “on top” of it. However, in this embodiment of the present invention, UNW 502 is removed by dynamic control of the UNW so that the user does not need to waste time and attention closing a UNW that is no longer relevant or applicable.

In a variation on this example, UNW 502 may be overwritten by simply removing it automatically (that is, removal of the UNW without active intervention of the user), such that UNW 504 is not displayed at all. In this variation UNW 502 merely disappears automatically upon resumption of the running of the server referenced in UNW 502. Because UNW 502 is overwritten automatically (that is, without intervention of the user to whom the UNW is displayed) after it has initially been displayed in its initial form, it is subject to a kind of control that is sometimes herein referred to as “dynamic control.”

Moving now to FIG. 7A, display 575A includes initial-form UNW 577A. UNW 577A relates to the installation of a patch needed for correct operation of a business application that is run across the enterprise. This business application patch requires the attention of one of a group of administrators (see FIG. 3 at reference numeral 201). It does not necessarily matter which administrator takes action, but one of the administrators does need to take action, as indicated by the text of UNW 577A. As shown in FIG. 7A, there is a button that will “take action”, but this needs to be clicked by one of the administrators. Moving now to FIG. 7B, another example of the dynamic control of the present invention becomes apparent. UNW 577A has been updated (or “overwritten”) into UNW 577B. As shown in screenshot 575B of FIG. 7B, UNW 577B indicates that an administrator (named Smith) has indeed taken action, and UNW 577B has also removed the “take action” button because Smith took the action that needed to be taken in response to the initial version of the UNW as shown in FIG. 7A.

Once again in this example, events occurring within the computer system, after the UNW is initially displayed, will affect the appearance of the UNW by the dynamic control provided by the present invention. In this case, the precondition that causes overwriting of the UNW displayed to the user is the result of an action taken by another user at some other client sub-system. Instead of withdrawing, or superseding the UNW, the UNW content is merely partially edited to reflect the intervening relevant events that have occurred in the system. Alternatively, UNW 577 could merely have been deleted automatically from the other administrators' respective displays after Smith has took the action that the initial-form UNW was requesting to be taken.

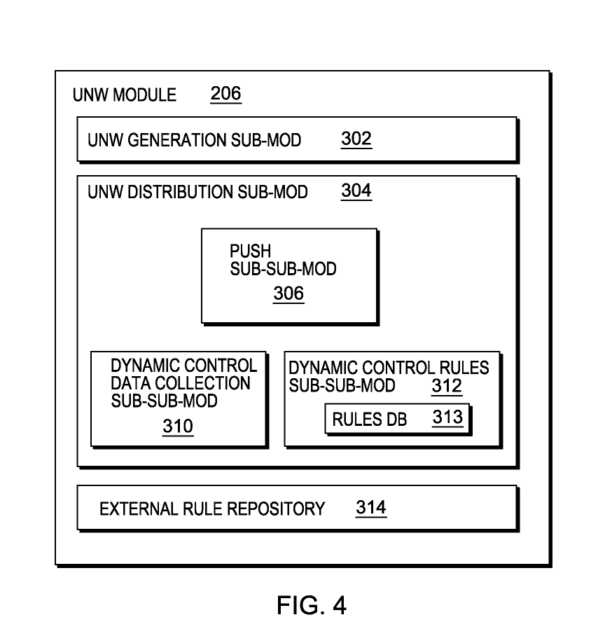

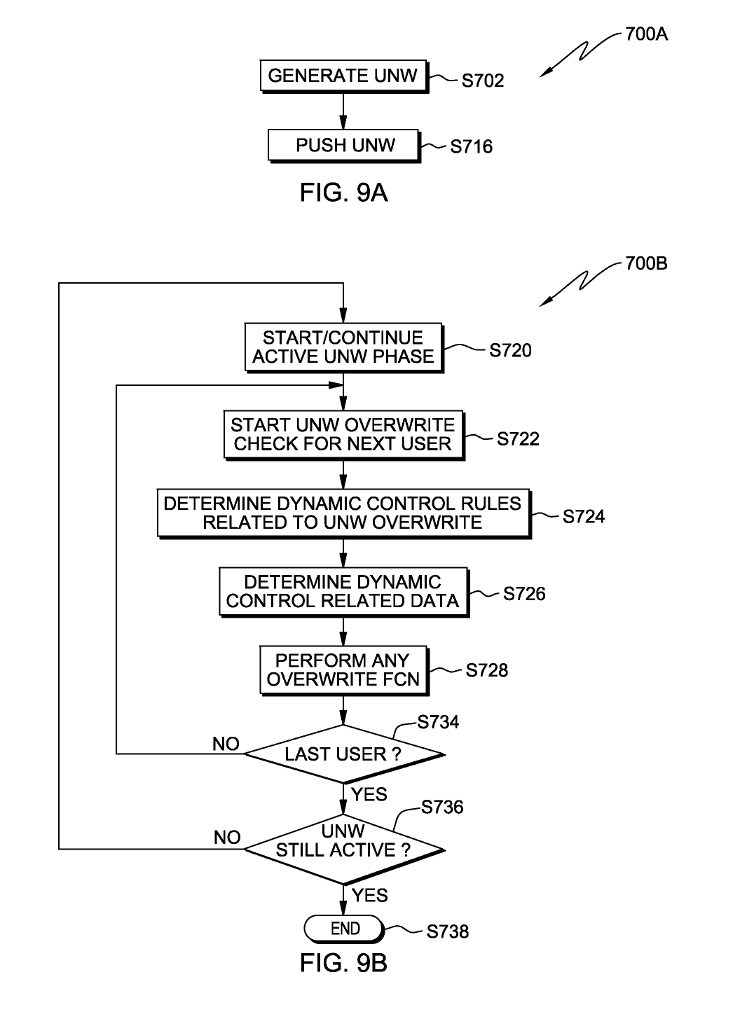

FIG. 9A is a flowchart depicting process 700A which represents some of the operational steps of UNW module 206 (see FIGS. 3 and 4) and/or UNW module 214 (see FIGS. 3 and 5). At step S702, UNW generation sub-module 302 and/or 402 generates an initial-form UNW for a user (or for a group of users) in the conventional way. This UNW generation generally is caused by detection of the existence of some sort of predetermined precondition (as is currently conventional for UNWs). As just one simple example, the precondition of the business application server being interrupted in service caused the display of initial-form UNW 502 in FIG. 6A.

At step S716, the UNW is distributed (or “pushed” to the appropriate recipient user(s)) by sub-sub-mod 408 and/or sub-sub-mod 306. Step S716 may be performed by currently conventional techniques for distributing UNWs to user(s). The UNW may also be stored along with data identifying the user(s) to whom the UNW was pushed because it may be helpful to have this information readily available later, when dynamic control of the UNW is performed. At step S716, the initial-form UNW will be displayed on each user(s) respective display device.

Process 700B will now be discussed with reference to FIGS. 4, 5 and 9B. Process 700B is performed by modules 206 (see FIG. 4) and/or 214 (see FIG. 5) to control UNW-related process flow after a particular initial-form UNW has been distributed to all applicable user(s). In process 700B there will be an opportunity to discuss the dynamic control of at least some embodiments of the present invention.

At step S720 of process 700B, process 700B starts.

At step S722, a particular UNW-recipient user is identified for ongoing continuing UNW dynamic control. This step is not really performed in embodiments where only a single UNW-recipient user receives the dynamically controlled UNW, but it does apply when a single initial-form UNW is sent to multiple users, like initial form UNW 502 of FIG. 6A, or initial-form UNW 577A of FIG. 7A.

At step S724, the applicable dynamic control rules are identified by sub-sub-module 312 (see FIG. 4) and/or sub-sub-module 412 (see FIG. 5). Sub-sub-module 312 applies applicable rules from rules database 313. Sub-sub-module 412 applies rules from its local rules database 413. Additionally, repository fetching sub-sub-sub mod 414 (see FIG. 5) may collect applicable dynamic control rules from external rule repository 314 (see FIG. 4) in order to apply the server central repository's rules locally at the client sub-system. Turning to the example shown in FIG. 6A, an applicable rule may be as follows: “if the initial-form UNW relates to a server interruption, and the server interruption ends, then overwrite the initial-form UNW.” In this example, the end of the server interruption is a precondition that causes overwriting of the second window. Many types of preconditions are possible. In the example of FIG. 7A, the precondition for dynamic control UNW-overwriting would be the fact that an administrator (other than the one seeing the UNW under dynamic control) has taken the needed action with respect to the patch.

At step S726, applicable data, related to the application of the dynamic control rules, is collected by sub-sub-modules 310 and/or 410. Under the dynamic control of the present invention, this data will generally: (i) relate to new data developed after the time at which the initial-form UNW was initially sent to the user(s); and (ii) will relate to something other than a response made by the user to whom the initial-form UNW under dynamic control is being displayed. In other words, if the recipient user closes the UNW, and thereby removes it from his display, this would not qualify as a form of dynamic control under the present invention.

At step S728, sub-sub mod 312 and/or sub-sub mod 412 apply the rule(s) identified at step S724 using the pre-condition-related data obtained at step S726 to determine whether the initial-form UNW should be overwritten, either by: (i) suppressing or withdrawing it entirely from the users display; or (ii) by editing the UNW based on changed circumstances. Sub-sub mod 312 and/or sub-sub mod 412 control the overwriting of the initial form UNW, as necessary.

At step S734 it is determined whether every recipient-user, for the given initial-form UNW push, has been checked for on-going dynamic UNW control and/or UNW related correspondence. If not, then processing loops back to step S722 to begin analysis on the next user. If every user has been analyzed in turn, then processing proceeds to decision step S736.

At step S736 it is determined whether all the applicable users have disposed of the UNW. If all users have disposed of the UNW then proceeds to step S738, where process 700B ends. If all users have not yet disposed of the UNW then processing loops back to step S720 so that all the users can once again be checked for ongoing dynamic UNW. It is noted that even if a UNW has been overwritten once, it may be possible to overwrite it again. For example: (i) an initial-form UNW may report a server interruption; a first overwritten UNW may edit the initial-form UNW to specify how long the server interruption is expected to last; and (iii) a second overwritten UNW may overwrite the first overwritten UNW to change the message to reflect that the server interruption has ended.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Some additional remarks will now be made. User interfaces of business applications are often considered as a key element with respect to customer perception of product quality. Some embodiments of the present invention are believed to improve the user interface and therefore improve customer perception of the application's quality. In some embodiments, the dynamic control of the present invention will facilitate: (i) the UNWs to relate more to the specific activity of the recipient-user; and/or (ii) avoid disturbing the recipient-user in his job. This can be sharply distinguished from the currently conventional static control of UNWs, which are typically unable to leverage any other experience on the same kind of message. Some embodiments of the present invention are believed to better fit UNW messages in a timely way. In some embodiments, the UNWs (or “light bulb like messages”) are not filtered a priori based on specific attributes, but relate on the message evolution in order to understand how the message is still interesting for the specific recipient.

In some embodiments, the UNW modules can be easily implemented leveraging the light bulb architecture in a collaborative way. In some embodiments, each message will have a unique identifier that can be used to track the message evolution by leveraging a mechanism similar to the one used for an email thread. So, according to such an approach, a message can be easily coupled to other messages creating sort of a UNW-hierarchy.

In some embodiments, at the receiver side, the client can configure a sort of collaborative group to be used to manage “not-needed” messages accordingly. These groups can also be gathered querying external repositories (like a company's enterprise wide area network based directory of employees) in order to retrieve the specific job role of a given recipient user.

In some embodiments, on the client side, a pluggable component is put in charge of providing a collaboration mechanism notifying other clients and/or the server about data related to application of the dynamic UNW control rules of the present invention. Based on the specifics of the client configuration, some messages may not be displayed on the basis that the potential-recipient-user is determined not to be interested in consuming that particular message. Alternatively, the UNW may be presented to that user in a different form and/or format.

In some embodiments, the logical flow will be as follows: (i) the server will mark the message in a way that allows the message to be superseded, answered or generically linked; (ii) the client provides a mechanism to define a set of user/collaborators and the rules of the message engagements; (iii) optionally the local rules can be enriched by external repositories information; (iv) user interface client plug-in when consuming a specific message will be in charge to put in place the collaborative mechanism; and (v) once a message is pushed to a client, the plug-in will automatically filter/mark the message according to the defined profile.

A potential advantage of some embodiments of the present invention is the capability to leverage the light bulb feature in a collaborative way having the same behavior of a scheduled/cancelled meeting before the meeting acceptance.

What is claimed is:

1. A method for controlling a user notification window (UNW), the method comprising the following steps:
generating, by a UNW module, a first initial-form UNW in response to detection of existence of a first precondition;
displaying, by the UNW module, the first initial-form UNW on a display device; and
subsequent to the displaying step, overwriting, by the UNW module and in response to detection of a second precondition, the display of the first initial-form UNW on the display device;
wherein:
the UNW module includes software running on processing hardware; and
the second precondition is a precondition other than a response made by a user of the display device.

2. The method of claim 1 wherein the first initial-form UNW relates to operation of a business application.

3. The method of claim 1 wherein the overwriting step includes the following sub-steps:
identifying a first applicable rule, with the first applicable rule being a rule that mandates overwriting of a UNW upon detection of existence of the second precondition;
detecting existence or non-existence of the second precondition; and
responsively overwriting the first initial-form UNW upon detection of the second precondition at the detecting sub-step.

4. The method of claim 3 wherein the overwriting of the first initial-form UNW removes the display of the first initial-form UNW from the display device without replacing the first initial-form UNW with another UNW.

5. The method of claim 3 wherein the overwriting of the first initial-form UNW replaces the first initial-form UNW with a first overwrite UNW.

6. The method of claim 5 wherein the first overwrite UNW includes human-readable information related to the second precondition.

7. A computer system comprising:
a set of processing hardware;
a display device; and
a user notification window (UNW) module;
wherein:
the processing hardware and/or the UNW module are adapted to generate a first initial-form UNW in response to detection of existence of a first precondition;
the processing hardware and/or the UNW module are further adapted to display the first initial-form UNW on the display device;
the processing hardware and/or the UNW module are further adapted to apply, in response to detection of a second precondition, control that overwrites the display of the first initial-form UNW on the display device; and
the second precondition is a precondition other than a response made by a user of the display device.

8. The system of claim 7 wherein the first initial-form UNW relates to operation of a business application.

9. The system of claim 7 wherein the processing hardware and/or the UNW module are further adapted to:
identify a first applicable rule, with the first applicable rule being a rule that mandates overwriting of a UNW upon detection of existence of the second precondition;
detect existence or non-existence of the second precondition; and
responsively overwrite the first initial-form UNW upon detection of the second precondition at the detecting sub-step.

10. The system of claim 9 wherein the processing hardware and/or the UNW module are further adapted to overwrite the first initial-form UNW by removing the display of the first initial-form UNW from the display device without replacing the first initial-form UNW with another UNW.

11. The system of claim 9 wherein the processing hardware and/or the UNW module are further adapted to overwrite the first initial-form UNW by replacing the first initial-form UNW with a first overwrite UNW.

12. The system of claim 11 wherein the first overwrite UNW includes human-readable information related to the second precondition.

13. A set of machine-readable instructions and data stored on a storage device in a form more persistent than a signal in transit, the set comprising a UNW module comprising:
a UNW generation sub-module; and
a UNW distribution sub-module;
wherein:
the UNW generation sub-module is adapted to generate a first initial-form UNW in response to detection of existence of a first precondition;
the UNW distribution sub-module is adapted to display the first initial-form UNW on the display device;
the UNW distribution sub-module is further adapted to apply, in response to detection of a second precondition, control that overwrites the display of the first initial-form UNW on the display device; and
the second precondition is a precondition other than a response made by a user of the display device.

14. The set of claim 13 wherein the first initial-form UNW relates to operation of a business application.

15. The set of claim 13 wherein the UNW distribution sub-module is further adapted to:
identify a first applicable rule, with the first applicable rule being a rule that mandates overwriting of a UNW upon detection of existence of the second precondition;
detect existence or non-existence of the second precondition; and
responsively overwrite the first initial-form UNW upon detection of the second precondition at the detecting sub-step.

16. The set of claim 15 wherein the UNW distribution sub-module is further adapted to overwrite the first initial-form UNW by removing the display of the first initial-form UNW from the display device without replacing the first initial-form UNW with another UNW.

17. The set of claim 15 wherein the UNW distribution sub-module is further adapted to overwrite the first initial-form UNW by replacing the first initial-form UNW with a first overwrite UNW.

18. The set of claim 17 wherein the first overwrite UNW includes human-readable information related to the second precondition.
